(19) United States
(12) Patent Application Publication
(10) Pub. No.: US 2026/0320958 A1
(43) Pub. Date: Oct. 15, 2026

(54) INFORMATION PROCESSING SYSTEM, INFORMATION PROCESSING METHOD, AND NON-TRANSITORY RECORDING MEDIUM

(71) Applicant: NEC Corporation, Tokyo (JP)

(72) Inventors: Ryo YAMAKABE, Tokyo (JP); Ryoma OAMI, Tokyo (JP); Yuka OGINO, Tokyo (JP); Masato SASAKI, Tokyo (JP); Akito SUGA, Tokyo (JP); Misao SHINA, Tokyo (JP); Masahiko OSAKA, Tokyo (JP); Megumi KIMURA, Tokyo (JP); Hirokazu HAMADA, Tokyo (JP)

(73) Assignee: NEC Corporation, Tokyo (JP)

(21) Appl. No.: 19/485,153

(22) PCT Filed: May 23, 2023
(86) PCT No.: PCT/JP2023/019124

§ 371 Date: Nov. 17, 2025

(51) Int. Cl. G06V 10/143; G06V 40/19

(52) U.S. Cl. CPC G06V 10/143; G06V 40/19; G06V 2201/07

(57) ABSTRACT

An information processing system includes: an image capture unit that captures a target image including an iris of a target; an image capture time acquisition unit that acquires an image capture time related to image capture by the image capture unit; and an adjustment unit that adjusts a setting value related to the image capture by the image capture unit, based on a change in a light environment corresponding to the image capture time. According to such an information processing system, it is possible to capture the target image with an appropriate setting value corresponding to the image capture time.

### TECHNICAL FIELD

The present disclosure relates to technical fields of an information processing system, an information processing method, and a recording medium.

### BACKGROUND ART

There is known a technique/technology in which a light environment, such as ambient light and lighting, is considered when biometric authentication using a target's face or iris is performed. For example, Patent Literature 1 discloses that an image is captured after controlling the lighting to meet a criterion for facial matching. Patent Literature 2 discloses that it is identified whether ambient light is captured in an iris image, and if so, a captured area is excluded and iris recognition is performed. Patent Literature 3 discloses that a tubular mechanism is provided to prevent ambient light from directly entering a camera.

### CITATION LIST

### Patent Literature

[Patent Literature 1] International Publication No. WO2021/144910
[Patent Literature 2] Japanese Patent Application Publication No. 2017-144086
[Patent Literature 3] Japanese Patent Application Publication No. 2009-205576

### SUMMARY

### Technical Problem

The present disclosure aims to improve the techniques/technologies disclosed in Citation List.

An information processing system according to an example aspect of the present disclosure includes: an image capture unit that captures a target image including an iris of a target; an image capture time acquisition unit that acquires an image capture time related to image capture by the image capture unit; and an adjustment unit that adjusts a setting value related to the image capture by the image capture unit, based on a change in a light environment corresponding to the image capture time.

An information processing method according to an example aspect of the present disclosure is an information processing method in an information processing system including an image capture unit that captures a target image including an iris of a target, the information processing method including: acquiring an image capture time related to image capture by the image capture unit; and adjusting a setting value related to the image capture by the image capture unit, based on a change in a light environment corresponding to the image capture time.

A recording medium according to an example aspect of the present disclosure is a recording medium on which a computer program is recorded, the computer program allowing an information processing method to be executed in an information processing system including an image capture unit that captures a target image including an iris of a target, the information processing method including: acquiring an image capture time related to image capture by the image capture unit; and adjusting a setting value related to the image capture by the image capture unit, based on a change in a light environment corresponding to the image capture time.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a block diagram illustrating a functional configuration of an information processing system according to a second example embodiment.

FIG. 5 is a flowchart illustrating a flow of operation of the information processing system according to the second example embodiment.

FIG. 6 is a block diagram illustrating a functional configuration of an information processing system according to a third example embodiment.

FIG. 7 is a flowchart illustrating a flow of operation of the information processing system according to the third example embodiment.

FIG. 8 is a block diagram illustrating a functional configuration of an information processing system according to a fourth example embodiment.

FIG. 9 is a flowchart illustrating a flow of a pre-calibration operation in the information processing system according to the fourth example embodiment.

FIG. 10 is a flowchart illustrating a flow of operation of the information processing system according to the fourth example embodiment.

FIG. 11 is a block diagram illustrating a functional configuration of an information processing system according to a fifth example embodiment.

FIG. 12 is a flowchart illustrating a flow of a pre-calibration operation in the information processing system according to the fifth example embodiment.

FIG. 13 is a flowchart illustrating a flow of operation of the information processing system according to the fifth example embodiment.

FIG. 14 is a block diagram illustrating a functional configuration of an information processing system according to a sixth example embodiment.

FIG. 15 is a flowchart illustrating a flow of a pre-calibration operation in the information processing system according to the sixth example embodiment.

FIG. 16 is a flowchart illustrating a flow of operation of the information processing system according to the sixth example embodiment.

FIG. 17 is a block diagram illustrating a functional configuration of an information processing system according to a seventh example embodiment.

FIG. 18 is a flowchart illustrating a flow of operation of the information processing system according to the seventh example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

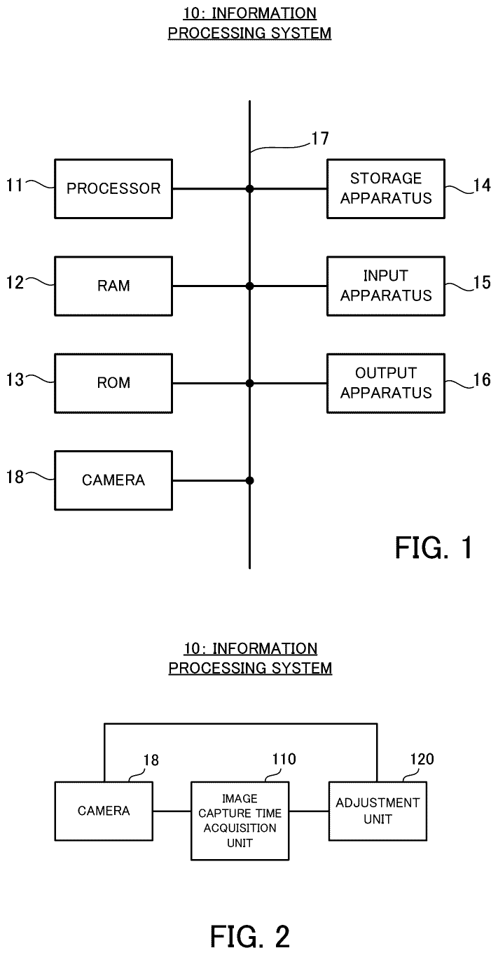

An information processing system according to a first example embodiment will be described with reference to FIG. 1 to FIG. 3.

### (Hardware Configuration)

First, with reference to FIG. 1, a hardware configuration of the information processing system according to the first example embodiment will be described. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, and a ROM (Read-Only Memory) 13. The information processing system 10 may further include a storage apparatus 14, an input apparatus 15, and an output apparatus 16. The information processing system 10 also includes a camera 18. The processor 11, the RAM 12, the ROM 13, the storage apparatus 14, the input apparatus 15, the output apparatus 16, and the camera 18 described above are connected via a data bus 17.

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may also acquire (i.e., read) a computer program from a not-illustrated apparatus disposed outside the information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a function block for adjusting a setting value of the camera depending on an image capture time is realized in the processor 11. That is, the processor 11 may function as a controller that performs each control in the information processing system 10.

The processor 11 may be configured, for example, as a CPU (Central Processing Unit), a GPU (Graphics Processing Unit), a FPGA (field-programmable gate array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by the processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the information processing system 10 for a long time. The storage apparatus 14 may operate as a transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be configured as a portable terminal such as a smartphone and a tablet. Furthermore, the output apparatus 16 may be an apparatus that outputs information in a format other than an image. For example, the output apparatus 16 may be a speaker that audio-outputs the information about the information processing system 10.

The camera 18 is configured to capture a target image including an iris of a target. Note that the target here is not limited to humans, and may include animals such as cats and dogs, robots, or the like. The camera 18 may be configured, for example, as a near-infrared camera. Furthermore, a plurality of cameras 18 may be provided. In such a case, the cameras 18 may include a plurality of types of cameras. For example, the cameras 18 may include a near-infrared camera and a visible light camera. Additionally, the camera 18 may be a camera that captures a still image, or a camera that captures a video. The camera 18 according to the present example embodiment is configured to adjust a setting value related to image capture (e.g., a camera parameter such as a gain and an exposure time), as described later.

A part of the hardware described in FIG. 1 may be provided as an external apparatus of the information processing system 10. For example, the information processing system 10 may be configured to include only the processor 11, the RAM 12, the ROM 13, and the camera 18 described above. The other components (i.e., the storage apparatus 14, the input apparatus 15, and the output apparatus 16) may be provided in an external apparatus connected to the information processing system 10. Furthermore, the information processing system 10 may realize a part of an arithmetic function by using an external apparatus (e.g., an external server or cloud, etc.).

### (Functional Configuration)

Next, with reference to FIG. 2, a functional configuration of the information processing system 10 according to the first example embodiment will be described. FIG. 2 is a block diagram illustrating the functional configuration of the information processing system according to the first example embodiment.

In FIG. 2, the information processing system 10 according to the first example embodiment is configured as a system that captures a target image with the camera 18. The camera 18 is configured to capture an image including at least the iris of the target. However, the camera 18 may also be configured to capture an image including an element other than the iris (e.g., a facial image, etc.). The information processing system 10 according to the first example embodiment may be installed in various facilities such as airports, stores, offices, and theme parks. In this case, the target image captured by the camera 18 may be used for biometric authentication in various facilities. For example, the target image may be provided as a system for determining whether or not the target is permitted to pass through a gate, by using iris recognition using feature quantities related to the iris of the target.

As illustrated in FIG. 2, the information processing system 10 according to the first example embodiment includes, as components for realizing its functions, the camera 18, an image capture time acquisition unit 110, and an adjustment unit 120. Each of the image capture time acquisition unit 110 and the adjustment unit 120 may be a processing block realized, for example, by the aforementioned processor 11 (see FIG. 1).

The image capture time acquisition unit 110 is configured to acquire an image capture time, which is a time related to the image capture by the camera 18. The image capture time may be information indicating not only a time indicating timing in which the image capture is performed, but also a time immediately before the image capture, a time immediately after the image capture, or a time zone in which the image capture is performed (e.g., what time, in the morning or the afternoon). The image capture time acquisition unit 110 may acquire the image capture time from the camera 18. Alternatively, the image capture time acquisition unit 110 may acquire the image capture time from a control unit that controls the camera 18, or the like. After the image capture is performed by the camera 18, the image capture time acquisition unit 110 may acquire a time at which previous image capture is performed. Alternatively, before the image capture is performed by the camera 18, the image capture time acquisition unit 110 may acquire a time at which next image capture is performed. Information about the image capture time acquired by the image capture time acquisition unit 110 is configured to be outputted to the adjustment unit 120.

The adjustment unit 120 is configured to adjust the setting value related to the image capture by the camera 18. The setting value here may include various camera parameters such as a shutter speed, a gain, and an aperture value. Alternatively, the setting value may include a parameter related to lighting used during the image capture by the camera 18 (e.g., parameters related to lighting intensity and direction). The adjustment unit 120 is configured to adjust the setting value of the camera, based on a change in the light environment corresponding to the image capture time acquired by the image capture time acquisition unit 110. For example, the adjustment unit 120 may perform adjustment to reduce the exposure of the camera 18 in a bright environment with a large amount of light. Alternatively, the adjustment unit 120 may perform adjustment to increase the exposure of the camera 18 in a dark environment with a small amount of light. The adjustment unit 120 may adjust the setting value at each time of the image capture by the camera 18, or may adjust the setting value in each predetermined period. Alternatively, the adjustment unit 120 may adjust the setting value upon detecting a specific user operation.

### (Flow of Operation)

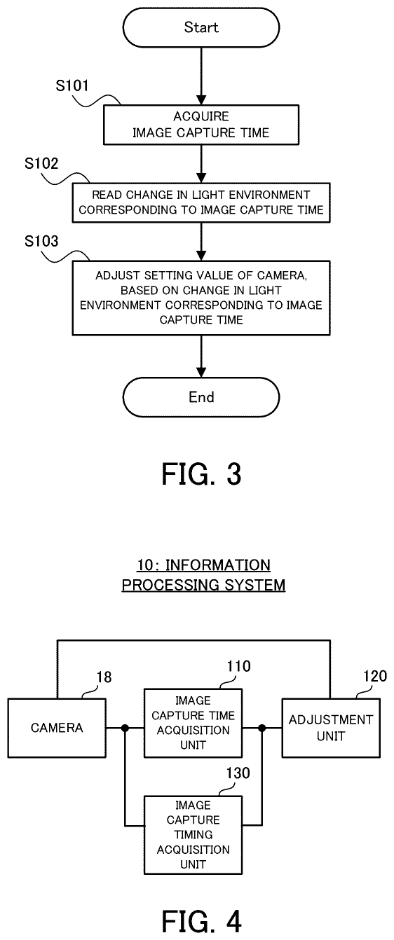

Next, with reference to FIG. 3, a flow of operation of the information processing system 10 according to the first example embodiment will be described. FIG. 3 is a flowchart illustrating the flow of the operation of the information processing system according to the first example embodiment.

As illustrated in FIG. 3, when the operation by the information processing system 10 according to the first example embodiment is started, first, the image capture time acquisition unit 110 acquires the image capture time (step S101). The information about the image capture time acquired by the image capture time acquisition unit 110 is outputted to the adjustment unit 120.

Then, the adjustment unit 120 reads information about the change in the light environment corresponding to the image capture time acquired by the image capture time acquisition unit 110 (hereinafter referred to as “light environment information” as appropriate) (step S102). The adjustment unit 120 may read the light environment information corresponding to the acquired image capture time, from the light environment information that is stored in advance. The light environment information corresponding to the image capture time may be stored in a storage unit that is provided separately from the adjustment unit 120. A specific configuration for storing the light environment information will be described in detail in another example embodiment later.

Then, the adjustment unit 120 adjusts the setting value related to the image capture by the camera 18, based on the read light environment information (step S103). After the adjustment unit 120 adjusts the setting value, the camera 18 may immediately capture images. Alternatively, after the adjustment unit 120 adjusts the setting value, the camera 18 may not immediately capture images, but instead, may capture images after a lapse of a predetermined time.

### (Technical Effect)

Next, a technical effect obtained by the information processing system 10 according to the first example embodiment will be described.

As described in FIG. 1 to FIG. 3, in the information processing system 10 according to the first example embodiment, the setting value related to the image capture is adjusted based on the change in the light environment corresponding to the image capture time. This enables the target image to be captured with the setting value corresponding to the image capture time. Specifically, even in locations where brightness or the direction of light changes depending on the image capture time, it is possible to prevent the image from being excessively bright or excessively dark, and to appropriately capture the target image. Such a technical effect is particularly pronounced in a case of performing processing that requires a high-quality image (e.g., in a case of performing iris recognition).

### Second Example Embodiment

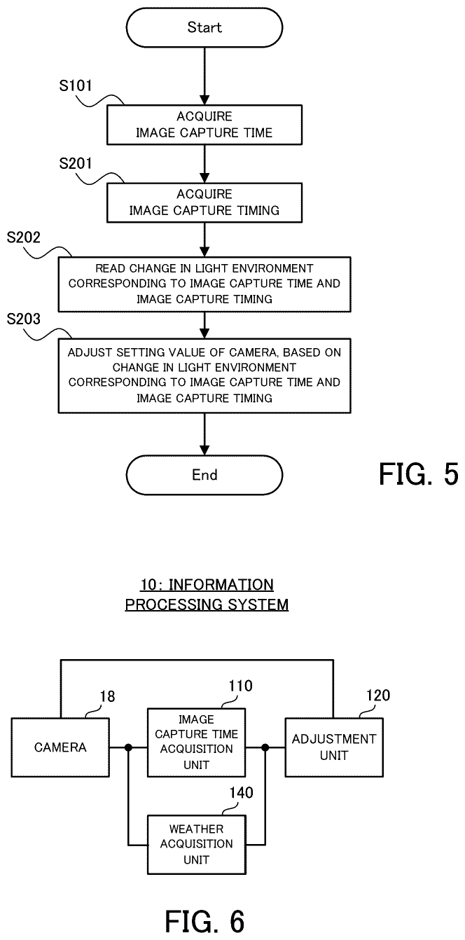

The information processing system 10 according to a second example embodiment will be described with reference to FIG. 4 and FIG. 5. The second example embodiment partially differs from the first example embodiment described above only in its configuration and operation, and may be the same as the first example embodiment in the other parts. Therefore, the following description will detail only a part differing from the already described first example embodiment, omitting a description of other overlapping parts as appropriate.

### (Functional Configuration)

First, with reference to FIG. 4, a functional configuration of the information processing system 10 according to the second example embodiment will be described. FIG. 4 is a block diagram illustrating the functional configuration of the information processing system according to the second example embodiment. In FIG. 4, the same components as those illustrated in FIG. 2 carry the same reference numerals.

As illustrated in FIG. 4, the information processing system 10 according to the second example embodiment includes, as components for realizing its functions, the camera 18, the image capture time acquisition unit 110, the adjustment unit 120, and an image capture timing acquisition unit 130. That is, the information processing system 10 according to the second example embodiment further includes the image capture timing acquisition unit 130 in addition to the configuration in the first example embodiment (see FIG. 2). The image capture timing acquisition unit 130 may be a processing block realized, for example, by the aforementioned processor 11 (see FIG. 1).

The image capture timing acquisition unit 130 is configured to acquire image capture timing, which is timing of capturing the target image with the camera 18. The image capture timing may be, for example, information indicating a season such as spring, summer, autumn, and winter, or information indicating a month such as January, August, and October. The image capture timing acquisition unit 130 may acquire the image capture timing, for example, from a calendar function of the camera 18. The image capture timing acquisition unit 130 may acquire the image capture timing from a calendar function of an apparatus other than the camera 18 (e.g., a smartphone, etc.). Alternatively, the image capture timing acquisition unit 130 may acquire the image capture timing by connecting to an external apparatus or the Internet, or the like. The image capture timing acquisition unit 130 may acquire the image capture timing in conjunction with the operation of the image capture time acquisition unit 110. For example, the image capture timing acquisition unit 130 may acquire the image capture timing each time the image capture time acquisition unit 110 acquires the image capture time. Information about the image capture timing acquired by the image capture timing acquisition unit 130 is configured to be outputted to the adjustment unit 120.

### (Flow of Operation)

Next, with reference to FIG. 5, a flow of operation of the information processing system 10 according to the second example embodiment will be described. FIG. 5 is a flowchart illustrating the flow of the operation of the information processing system according to the second example embodiment. In FIG. 5, the same steps as those described in FIG. 3 carry the same reference numerals.

As illustrated in FIG. 5, when the operation by the information processing system 10 according to the second example embodiment is started, first, the image capture time acquisition unit 110 acquires the image capture time (step S101). Then, the image capture timing acquisition unit 130 acquires the image capture timing (step S201). Note that the step S101 and the step S201 may be performed either sequentially or simultaneously in parallel. Each of the information about the image capture time acquired by the image capture time acquisition unit 110 and the information about the image capture timing acquired by the image capture timing acquisition unit 130 is outputted to the adjustment unit 120.

Then, the adjustment unit 120 reads the light environment information corresponding to the image capture time acquired by the image capture time acquisition unit 110 and the image capture timing acquired by the image capture timing acquisition unit 130 (step S202). That is, the adjustment unit 120 reads the light environment information corresponding to both the image capture time and the image capture timing. For example, in a case where the acquired image capture time is “11:00 AM” and the image capture timing is “spring,” the adjustment unit reads the light environment information corresponding to “11:00 AM in spring.”

Then, the adjustment unit 120 adjusts the setting value related to the image capture by the camera 18, based on the read light environment information (step S203). That is, the adjustment unit 120 adjusts the setting value, based on the light environment information corresponding to both the image capture time and the image capture timing.

### (Technical Effect)

Next, a technical effect obtained by the information processing system 10 according to the second example embodiment will be described.

As described in FIG. 4 and FIG. 5, in the information processing system 10 according to the second example embodiment, the setting value related to the image capture is adjusted in view of the change in the light environment corresponding to the image capture timing, in addition to the image capture time. This enables the target image to be captured with an appropriate setting value corresponding to the image capture timing. Specifically, even in locations where brightness or the direction of light changes depending on the image capture timing, it is possible to appropriately capture the target image.

### Third Example Embodiment

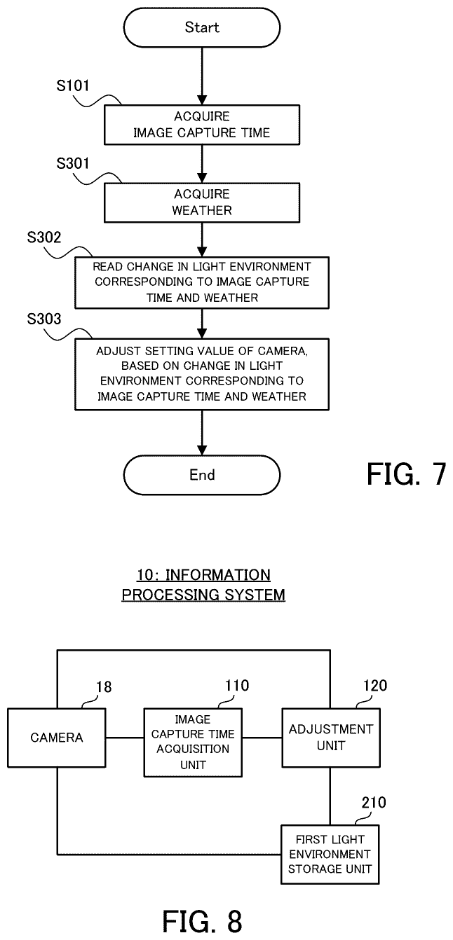

The information processing system 10 according to a third example embodiment will be described with reference to FIG. 6 and FIG. 7. The third example embodiment partially differs from the first and second example embodiments described above only in its configuration and operation, and may be the same as the first and second example embodiments in the other parts. Therefore, the following description will detail only a part differing from the already described example embodiments, omitting a description of other overlapping parts as appropriate.

### (Functional Configuration)

First, with reference to FIG. 6, a functional configuration of the information processing system 10 according to the third example embodiment will be described. FIG. 6 is a block diagram illustrating the functional configuration of the information processing system according to the third example embodiment. In FIG. 6, the same components as those illustrated in FIG. 2 carry the same reference numerals.

As illustrated in FIG. 6, the information processing system 10 according to the third example embodiment includes, as components for realizing its functions, the camera 18, the image capture time acquisition unit 110, the adjustment unit 120, and a weather acquisition unit 140. Specifically, the information processing system 10 according to the third example embodiment further includes the weather acquisition unit 140, in addition to the configuration in the first example embodiment (see FIG. 2). The weather acquisition unit 140 may be a processing block realized, for example, by the aforementioned processor 11 (see FIG. 1).

The weather acquisition unit 140 is configured to acquire weather when the camera 18 captures the target image. The weather may be, for example, information indicating specific weather conditions such as sunny, cloudy, and rainy. Alternatively, the weather may be information indicating precipitation probability, precipitation amount, temperature, wind direction, and the like. The weather acquisition unit 140 may acquire the weather by connecting to an external apparatus or the Internet, or the like. Alternatively, the weather acquisition unit 140 may acquire weather information from scenery or background included in the image captured by the camera 18. For example, the weather acquisition unit 140 may be configured to estimate the weather information, based on image brightness or cloud patterns included in the image. A machine learning model may be used to estimate the weather information. The weather acquisition unit 140 may acquire the image capture time in coordination with the operation of the image capture time acquisition unit 110. For example, the weather acquisition unit 140 may acquire the weather each time the image capture time acquisition unit 110 acquires the image capture time. The weather information about the weather acquired by the weather acquisition unit 140 is configured to be outputted to the adjustment unit 120.

### (Flow of Operation)

Next, with reference to FIG. 7, a flow of operation of the information processing system 10 according to the third example embodiment will be described. FIG. 7 is a flowchart illustrating the flow of the operation of the information processing system according to the third example embodiment. In FIG. 7, the same steps as those described in FIG. 3 carry the same reference numerals.

As illustrated in FIG. 7, when the operation by the information processing system 10 according to the third example embodiment is started, first, the image capture time acquisition unit 110 acquires the image capture time (step S101). Then, the weather acquisition unit 140 acquires the weather at the time of image capture (step S301). The step S101 and the step S301 may be executed performed sequentially or simultaneously in parallel. Each of the information about the image capture time acquired by the image capture time acquisition unit 110 and the information about the weather acquired by the weather acquisition unit 140 is outputted to the adjustment unit 120.

Then, the adjustment unit 120 reads the light environment information corresponding to the image capture time acquired by the image capture time acquisition unit 110 and the weather acquired by the weather acquisition unit 140 (step S302). That is, the adjustment unit 120 reads the light environment information corresponding to both the image capture time and the weather. For example, in a case where the acquired image capture time is “1:00 PM” and the weather is “sunny,” the adjustment unit reads the light environment information corresponding to “1:00 PM on a sunny day.”

Then, the adjustment unit 120 adjusts the setting value related to the image capture by the camera 18, based on the read light environment information (step S303). That is, the adjustment unit 120 adjusts the setting value, based on the light environment information corresponding to both the image capture time and the weather.

### (Technical Effect)

Next, a technical effect obtained by the information processing system 10 according to the third example embodiment will be described.

As described in FIG. 6 and FIG. 7, in the information processing system 10 according to the third example embodiment, the setting value related to the image capture is adjusted in view of the change in the light environment corresponding to the weather, in addition to the image capture time. This enables the target image to be captured with an appropriate setting value corresponding to the weather. Specifically, even in locations where brightness or the direction of light changes depending on the weather, it is possible to appropriately capture the target image.

The information processing system 10 according to the third example embodiment may also include the image capture timing acquisition unit 130 (see FIG. 4) described in the second example embodiment, in addition to the weather acquisition unit 140. In this case, the adjustment unit 130 may adjust the setting value of the camera 18, based on the change in the light environment corresponding to the image capture time, the image capture timing, and the weather.

### Fourth Example Embodiment

The information processing system 10 according to a fourth example embodiment will be described with reference to FIG. 8 to FIG. 10. The fourth example embodiment partially differs from the first to third example embodiments described above only in its configuration and operation, and may be the same as those of the first to third example embodiments in the other parts. Therefore, the following description will detail only a part differing from the already described example embodiments, omitting a description of other overlapping parts as appropriate.

### (Functional Configuration)

First, with reference to FIG. 8, a functional configuration of the information processing system 10 according to the fourth example embodiment will be described. FIG. 8 is a block diagram illustrating the functional configuration of the information processing system according to the fourth example embodiment. In FIG. 8, the same components as those illustrated in FIG. 2 carry the same reference numerals.

As illustrated in FIG. 8, the information processing system 10 according to the fourth example embodiment includes, as components for realizing its functions, the camera 18, the image capture time acquisition unit 110, the adjustment unit 120, and a first light environment storage unit 210. That is, the information processing system 10 according to the fourth example embodiment further includes the first light environment storage unit 210, in addition to the configuration in the first example embodiment (see FIG. 2). The first light environment storage unit 210 may be realized, for example, by the processor 11 and the storage apparatus 14 described above (see FIG. 1).

The first light environment storage unit 210 is configured to generate and store first light environment information. The first light environment information is information indicating a relation between the image capture time and the change in the light environment at a location where the target image is captured. For example, the first light environment information may be information stored by associating the image capture time with the light environment corresponding to that time. The first light environment storage unit 210 generates the first light environment information by performing preliminary image capture. Specifically, the first light environment storage unit 210 generates the first light environment information by performing the preliminary image capture using an object with reflectance similar to that of an iris to near-infrared light (hereinafter appropriately referred to as an “adjustment member”). The adjustment member may be made of a material with reflectance close to that of the iris (e.g., a material in which a difference in reflectance falls within a predetermined value). The adjustment member may also be an object made to resemble a shape of the iris (e.g., a spherical member). By performing the preliminary image capture using the adjustment member, it is possible to accurately understand/assess the change in the light environment when the iris is actually illuminated with near-infrared light for the image capture. A camera that performs the preliminary image capture may be the same camera as the camera 18 that captures the target image, or may be another camera of the same type or with similar performance. The first light environment information stored in the first light environment storage unit 210 is readable by the adjustment unit 120 as appropriate.

### (Pre-Calibration Operation)

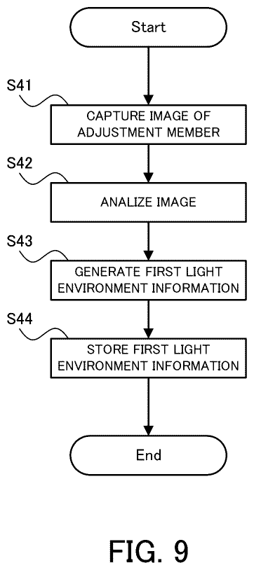

Next, with reference to FIG. 9, a pre-calibration operation in the information processing system 10 according to the fourth example embodiment will be described. FIG. 9 is a flowchart illustrating a flow of the pre-calibration operation in the information processing system according to the fourth example embodiment.

As illustrated in FIG. 9, in the information processing system 10 according to the fourth example embodiment, the pre-calibration operation for storing first optical storage information is performed. In the pre-calibration operation according to the fourth example embodiment, first, an image of the adjustment member is captured (step S41). An instruction to capture the image of the adjustment member may be outputted by the first light environment storage unit 210.

Then, the first light environment storage unit 210 analyzes the captured image of the adjustment member (step S42). The analysis here is processing for generating the first light environment information, and may be, for example, processing for obtaining pixel values (brightness) of the image. In a case where a plurality of images of the adjustment member are captured, the first light environment storage unit 210 may analyze on each of the plurality of images.

Then, the first light environment storage unit 210 generates the first light environment information from an analysis result of the image (step S43). The first light environment information may be generated from analysis results of a plurality of images. For example, the first light environment information may be generated from analysis results of a plurality of images captured in different time zones. Finally, the first light environment storage unit 210 stores the generated first light environment information (step S44).

### (Flow of Operation)

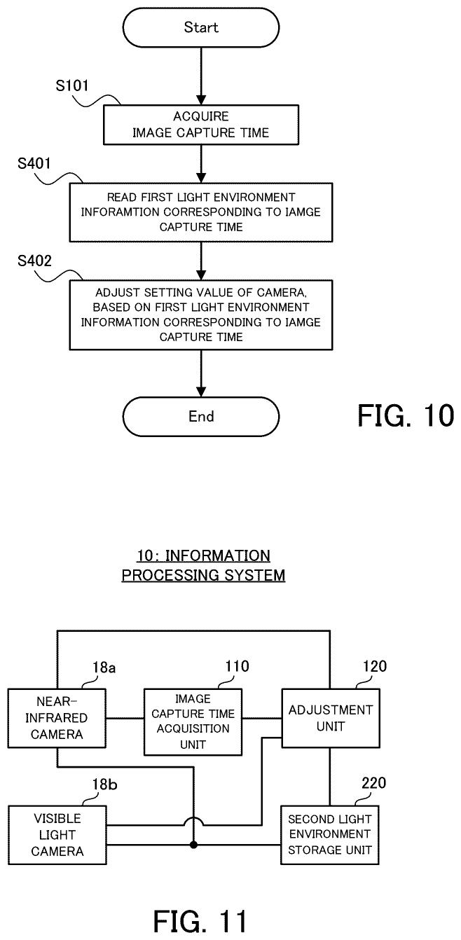

Next, with reference to FIG. 10, a flow of operation of the information processing system 10 according to the fourth example embodiment will be described. FIG. 10 is a flowchart illustrating the flow of the operation of the information processing system according to the fourth example embodiment. In FIG. 10, the same steps as those described in FIG. 3 carry the same reference numerals.

As illustrated in FIG. 10, when the operation by the information processing system 10 according to the fourth example embodiment is started, first, the image capture time acquisition unit 110 acquires the image capture time (step S101). The information about the image capture time acquired by the image capture time acquisition unit 110 is outputted to the adjustment unit 120

Then, the adjustment unit 120 reads the first light environment information corresponding to the image capture time acquired by the image capture time acquisition unit 110, from the first light environment information stored in the first light environment storage unit 210 (step S401). Then, the adjustment unit 120 adjusts the setting value related to the image capture by the camera 18, based on the read first light environment information (step S402). That is, the adjustment unit 120 adjusts the setting value related to the image capture, based on the change in the light environment indicated by the read first light environment information.

(Technical Effect)

Next, a technical effect obtained by the information processing system 10 according to the fourth example embodiment will be described.

As described in FIG. 8 to FIG. 10, in the information processing system 10 according to the fourth example embodiment, the setting value is adjusted based on the first light environment information generated by the preliminary image capture. Since the first light environment information is information generated by the preliminary image capture using the object with reflectance similar to that of the iris to near-infrared light, it accurately reflects the change in the light environment corresponding to the image capture time. Therefore, by using the first light environment information to adjust the setting value, it is possible to adjust the setting value, easily and accurately.

### Fifth Example Embodiment

The information processing system 10 according to a fifth example embodiment will be described with reference to FIG. 11 to FIG. 13. The fifth example embodiment partially differs from the first to fourth example embodiments described above only in its configuration and operation, and may be the same as the first to fourth example embodiments in the other parts. Therefore, the following description will detail only a part differing from the already described example embodiments, omitting a description of other overlapping parts as appropriate.

### (Functional Configuration)

First, with reference to FIG. 11, a functional configuration of the information processing system 10 according to the fifth example embodiment will be described. FIG. 11 is a block diagram illustrating the functional configuration of the information processing system according to the fifth example embodiment. In FIG. 11, the same components as those described in FIG. 2 carry the same reference numerals.

As illustrated in FIG. 11, the information processing system 10 according to the fifth example embodiment includes, as components for realizing its functions, a near-infrared camera 18a, a visible light camera 18b, the capture time acquisition unit 110, the adjustment unit 120, and a second light environment storage unit 210. That is, the information processing system 10 according to the fourth example embodiment includes two types of cameras 18 (the near-infrared camera 18a and the visible light camera 18b). The near-infrared camera 18a may be configured as a camera for capturing the target image (i.e., the image including the iris of the target), while the visible light camera 18b may be configured as a camera for capturing an image other than the target image (e.g., an image used for auxiliary purposes). Furthermore, the information processing system 10 according to the fifth example embodiment further includes the second light environment storage unit 220, in addition to the configuration in the first example embodiment (see FIG. 2). The second light environment storage unit 220 may be realized, for example, by the processor 11 and the storage apparatus 14 described above (see FIG. 1).

The second light environment storage unit 220 is configured to generate and store second light environment information. The second light environment information is information indicating a relation between the image capture time and changes in a visible light environment and a near-infrared light environment at a location where the target image is captured. For example, the second light environment information may be information stored by associating the image capture time with the visible light environment and the near-infrared light environment corresponding to that time. The second light environment storage unit 220 generates the second light environment information by performing the preliminary image capture. Specifically, the second light environment storage unit 220 generates the second light environment information by performing the preliminary image capture using the near-infrared camera and the visible light camera. For example, the second light environment storage unit 220 may generate the second light environment information by analyzing each of a near-infrared image and a visible light image captured in the same timing (or in the same time zone). By performing such preliminary image capture, it is possible to accurately understand/assess the change in the light environment related to the near-infrared light corresponding to the image capture time, and the change in the light environment related to the visible light corresponding to the image capture time. A camera that performs the preliminary image capture may be the same camera as the camera that captures the target image (i.e., the near-infrared camera 18a and the visible light camera 18b), or may be another camera of the same type or with similar performance. The second light environment information stored in the second light environment storage unit 220 is readable by the adjustment unit 120 as appropriate.

### (Pre-Calibration Operation)

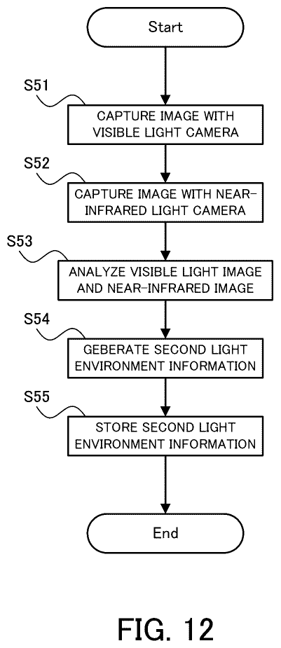

Next, with reference to FIG. 12, a pre-calibration operation in the information processing system 10 according to the fifth example embodiment will be described. FIG. 12 is a flowchart illustrating a flow of the pre-calibration operation in the information processing system according to the fifth example embodiment.

As illustrated in FIG. 12, in the information processing system 10 according to the fifth example embodiment, the pre-calibration operation for storing second optical storage information is performed. In the pre-calibration operation according to the fifth example embodiment, first, the preliminary image capture is performed with the visible light camera 18b (step S51). Then, the preliminary image capture is performed with the near-infrared camera 18a (step S52). The step S51 and the step S52 may be performed sequentially or simultaneously in parallel. These preliminary image capture may be capturing the image of the adjustment member, as described in the fourth example embodiment.

Then, the second light environment storage unit 220 analyzes each of the visible light image captured by the visible light camera 18b and the near-infrared image captured by the near-infrared camera 18a (step S53). The analysis here is processing for generating the second light environment information, and may be, for example, processing for obtaining pixel values (brightness) of the images. If a plurality of visible light images and a plurality of near-infrared images are captured, the second light environment storage unit 220 may analyze each of the plurality of images.

Then, the second light environment storage unit 220 generates the second light environment information from analysis results of the images (step S54). The second light environment information may be generated from analysis results of the visible light image and the near-infrared image captured in the same time zone. For example, the second light environment information may be generated from the analysis results of the visible light image and the near-infrared image captured at 9:00 AM, the analysis results of the visible light image and the near-infrared image captured at 10:00 AM, and the analysis results of the visible light image and the near-infrared image captured at 11:00 AM. Finally, the second light environment storage unit 220 stores the generated second light environment information (step S55).

### (Flow of Operation)

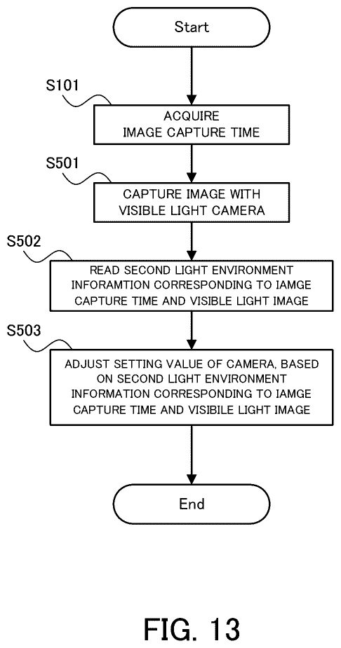

Next, with reference to FIG. 13, a flow of operation of the information processing system 10 according to the fifth example embodiment will be described. FIG. 13 is a flowchart illustrating the flow of the operation of the information processing system according to the fifth example embodiment. In FIG. 13, the same steps as those described in FIG. 3 carry the same reference numerals.

As illustrated in FIG. 13, when the operation by the information processing system 10 according to the fifth example embodiment is started, first, the image capture time acquisition unit 110 acquires the image capture time (step S101). The information about the image capture time acquired by the image capture time acquisition unit 110 is outputted to the adjustment unit 120.

Then, the adjustment unit 120 controls the visible light camera 18b to capture an image of the target (step S501). The visible light image captured here is acquired by the adjustment unit 120.

Then, the adjustment unit 120 reads the second light environment information corresponding to the image capture time acquired by the image capture time acquisition unit 110 and the visible light image captured by the visible light camera 18b, from the second light environment information stored in the second light environment storage unit 220 (step S502). For example, the adjustment unit 120 reads a piece of second light environment information indicating the light environment that is the closest to a light environment in which the visible light image is captured, from among a plurality of pieces of second light environment information corresponding to the acquired image capture time.

Then, the adjustment unit 120 adjusts the setting value related to the image capture by the near-infrared camera 18a, based on the read second light environment information (step S503). That is, the adjustment unit 120 adjusts the setting value related to the image capture by the near-infrared camera 18a, based on the change in the near-infrared light environment indicated by the read second light environment information.

### (Technical Effect)

Next, a technical effect obtained by the information processing system 10 according to the fifth example embodiment will be described.

As described in FIG. 11 to FIG. 13, in the information processing system 10 according to the fifth example embodiment, the setting value is adjusted based on the visible light image captured by the visible light camera 18b and the second light environment information. This enables the calculation of the setting value of the near-infrared camera 18a corresponding to the image capture time from the visible light image (i.e., a current light environment related to the visible light) and the second light environment information, thereby allowing the setting value to be adjusted, more easily and accurately.

### Sixth Example Embodiment

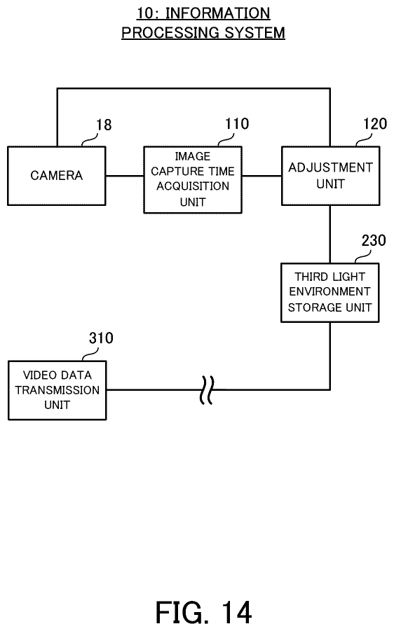

The information processing system 10 according to a sixth example embodiment will be described with reference to FIG. 14 to FIG. 16. The sixth example embodiment partially differs from the first to fifth example embodiments described above only in its operations, and may be the same as the first to fifth example embodiments in the other parts. Therefore, the following description will detail only a part differing from the already described example embodiments, omitting a description of other overlapping parts as appropriate.

### (Functional Configuration)

First, with reference to FIG. 14, a functional configuration of the information processing system 10 according to the sixth example embodiment will be described. FIG. 14 is a block diagram illustrating the functional configuration of the information processing system according to the sixth example embodiment. In FIG. 14, the same components as those illustrated in FIG. 2 carry the same reference numerals.

As illustrated in FIG. 14, the information processing system 10 according to the sixth example embodiment includes, as components for realizing its functions, the camera 18, the image capture time acquisition unit 110, the adjustment unit 120, a third light environment storage unit 210, and a video data transmission unit 310. Specifically, the information processing system 10 according to the sixth example embodiment further includes the third light environment storage unit 210 and the video data transmission unit 310, in addition to the configuration in the first example embodiment (see FIG. 2). Each of the third light environment storage unit 210 and the video data transmission unit 310 may be realized, for example, by the processor 11 and the storage apparatus 14 described above (see FIG. 1).

The video data transmission unit 310 is configured to transmit video data captured at a location where the target image is captured, to a remote location. Specifically, the video data transmission unit 310 transmits the video data captured at the location where the target image is captured, to a location where there is a third light environment storage unit 230. For example, the video data transmission unit 310 may transmit video data captured at a facility where the camera 18 is installed, to a factory where a system including the camera 18 is manufactured, or a similar location. The video data transmission unit 310 may be configured to transmit the video data, for example, by using wireless communication. By enabling the transmission of the video data to a remote location, it is possible to perform pre-calibration at a different location from an actual image capture location. It is preferable that the video data include a plurality of pieces of data captured at different times, so as to understand/assess the change in the light environment corresponding to the image capture time. A camera that captures a video may be the same camera as the camera 18 that captures the target image, or may be another camera of the same type or with similar performance.

The third light environment storage unit 230 is configured to generate and store third light environment information. The third light environment information is information indicating a relation between the image capture time and the change in the light environment at a location where camera 18 is installed. For example, the third light environment information may be information stored by associating the image capture time with the light environment corresponding to that time. The third light environment storage unit 230 generates the third light environment information, based on the video data captured at the location where the camera 18 is installed (i.e., the video data transmitted by the video data transmission unit 310). The use of the video data makes it possible to accurately understand/assess the change in the light environment corresponding to the image capture time (i.e., the change in the light environment over time). The third light environment information stored in the third light environment storage unit 230 is readable by the adjustment unit 120 as appropriate.

### (Pre-Calibration Operation)

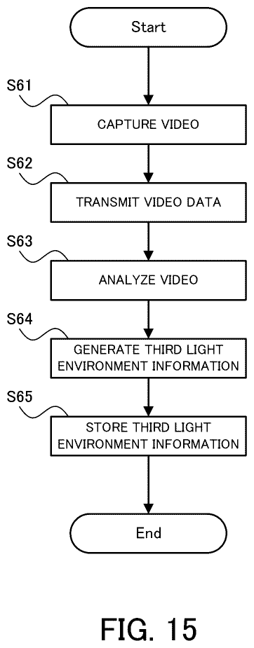

Next, with reference to FIG. 15, a pre-calibration operation in the information processing system 10 according to the sixth example embodiment will be described. FIG. 15 is a flowchart illustrating the flow of the pre-calibration operation in the information processing system according to the sixth example embodiment.

As illustrated in FIG. 15, in the information processing system 10 according to the sixth example embodiment, the pre-calibration operation for storing third optical storage information is performed. In the pre-calibration operation according to the sixth example embodiment, first, the video is captured (step S61). An instruction to capture the video may be outputted by the video data transmission unit 310 or the third light environment storage unit 230.

Then, the video data transmission unit 310 transmits the captured video data to the third light environment storage unit 230 (step S62). Then, the third light environment storage unit 230 analyzes the transmitted video data (step S63). The analysis here is processing for generating the third light environment information, and may be, for example, processing for obtaining pixel values (brightness) of each frame included in the video data.

Then, the third light environment storage unit 230 generates the third light environment information from an analysis result of the video data (step S64). The third light environment information may be generated from an analysis result in each time zone of the video data. For example, the third light environment information may be information indicating the change in the light environment in each time zone, such as an analysis result of a 10:00 AM part, an analysis result of a 11:00 AM part, and an analysis result of a 12:00 PM part of the video data. Finally, the third light environment storage unit 230 stores the generated third light environment information (step S65).

### (Flow of Operation)

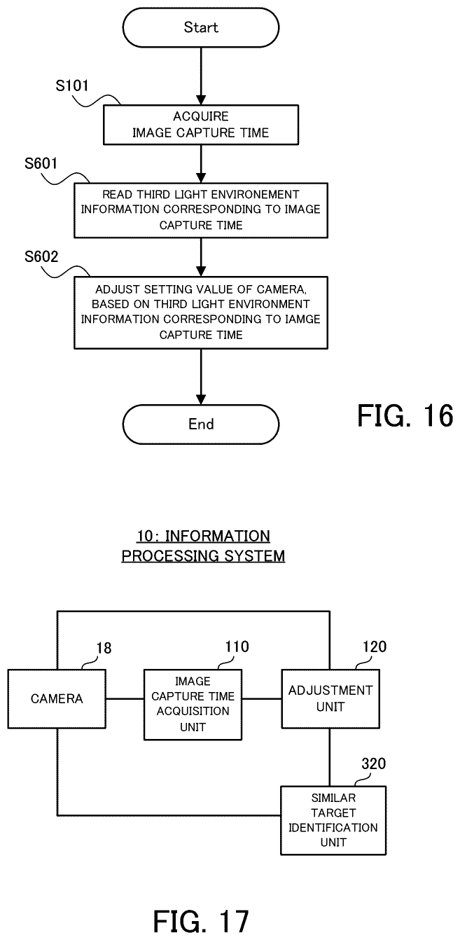

Next, with reference to FIG. 16, a flow of operation of the information processing system 10 according to the sixth example embodiment will be described. FIG. 16 is a flowchart illustrating the flow of the operation of the information processing system according to the sixth example embodiment. In FIG. 16, the same steps as those described in FIG. 3 carry the same reference numerals.

As illustrated in FIG. 16, when the operation by the information processing system 10 according to the sixth example embodiment is started, first, the image capture time acquisition unit 110 acquires the image capture time (step S101). The information about the image capture time acquired by the image capture time acquisition unit 110 is outputted to the adjustment unit 120.

Then, the adjustment unit 120 reads the third light environment information corresponding to the image capture time acquired by the image capture time acquisition unit 110, from the third light environment information stored in the third light environment storage unit 230 (step S601). Then, the adjustment unit 120 adjusts the setting value related to the image capture by the camera 18, based on the read third light environment information (step S602). That is, the adjustment unit 120 adjusts the setting value related to the image capture, based on the change in the light environment indicated by the read third light environment information.

### (Technical Effect)

Next, a technical effect obtained by the information processing system 10 according to the sixth example embodiment will be described.

As described in FIG. 14 to FIG. 16, in the information processing system 10 according to the sixth example embodiment, the setting value is adjusted based on the third light environment information generated from the video data. This enables the calculation of the setting value corresponding to the image capture time from the third light environment information, thereby allowing the setting value to be adjusted, more easily and accurately.

### Seventh Example Embodiment

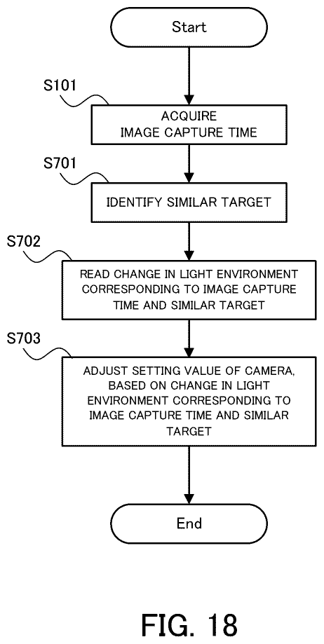

The information processing system 10 according to a seventh example embodiment will be described with reference to FIG. 17 and FIG. 18. The seventh example embodiment partially differs from the first to sixth example embodiments described above only in its operation, and may be the same as the first to sixth example embodiments in the other parts. Therefore, the following description will detail only a part differing from the already described example embodiments, omitting a description of other overlapping parts as appropriate.

### (Functional Configuration)

First, with reference to FIG. 17, a functional configuration of the information processing system 10 according to the seventh example embodiment will be described. FIG. 17 is a block diagram illustrating the functional configuration of the information processing system according to the seventh example embodiment. In FIG. 17, the same components as those illustrated in FIG. 2 carry the same reference numerals.

As illustrated in FIG. 17, the information processing system 10 according to the seventh example embodiment includes, as components for realizing its functions, the camera 18, the image capture time acquisition unit 110, the adjustment unit 120, and a similar target identification unit 320. Specifically, the information processing system 10 according to the seventh example embodiment further includes the similar target identification unit 320m in addition to the configuration in the first example embodiment (see FIG. 2). The similar target identification unit 320 may be realized, for example, by the processor 11 and the storage apparatus 14 described above (see FIG. 1).

The similar target identification unit 320 identifies, from among a plurality of targets previously captured by the camera 18, a target with a height close to that of a current target (i.e., a target to be captured next) (hereinafter referred to as a “similar target” as appropriate). The similar target identification unit 320 may, for example, store the height of the target each time it is captured and compare the height of the current target with those of past targets (i.e., stored heights), thereby identifying the similar target. In a case where there is no target with the same height as that of the current target in the past, the similar target identification unit 320 may identify a past target with the closest height to that of the current target, as the similar target. Furthermore, in a case where there are a plurality of targets with the same height as that of the current target in the past, the similar target identification unit 320 may identify any one of the past targets with the same height as the similar target, or may identify all the past targets with the same height as the similar targets. That is, a plurality of similar targets may be identified. Information about the similar target identified by the similar target identification unit 320 is configured to be outputted to the adjustment unit 120.

### (Flow of Operation)

Next, with reference to FIG. 18, a flow of operation of the information processing system 10 according to the seventh example embodiment will be described. FIG. 18 is a flowchart illustrating the flow of the operation of the information processing system according to the seventh example embodiment. In FIG. 18, the same steps as those described in FIG. 3 carry the same reference numerals.

As illustrated in FIG. 18, when the operation by the information processing system 10 according to the seventh example embodiment is started, first, the image capture time acquisition unit 110 acquires the image capture time (step S101). The information about the image capture time acquired by the image capture time acquisition unit 110 is outputted to the adjustment unit 120.

Then, the similar target identification unit 320 identifies the similar target with a height close to that of the current target (step S701). Then, the adjustment unit 120 reads the information corresponding to the image capture time acquired by the image capture time acquisition unit 110 and indicating the change in the lighting environment when the similar target is captured in the past (step S702). For example, in a case where the acquired image capture time is “3:00 PM” and a previously captured target “person A” is identified as the similar target, the adjustment unit 120 reads “information indicating the change in the light environment when the person A is captured at 3:00 PM.”

Then, the adjustment unit 120 adjusts the setting value related to the image capture by the camera 18, based on the read light environment information (step S702). That is, the adjustment unit 120 adjusts the setting value related to the image capture, based on the change in the light environment corresponding to the image capture time and the similar target.

### (Technical Effect)

Next, a technical effect obtained by the information processing system 10 according to the seventh example embodiment will be described.

As described in FIG. 17 and FIG. 18, in the information processing system 10 of the seventh example embodiment, the setting value is adjusted based on the change in the light environment when the similar target is captured in the past. In this way, not only the image capture time, but also the change in the light environment corresponding to the target's height (e.g., a difference in how light falls on a taller person and on a shorter person, etc.) are taken into account, and it is therefore possible to capture the target image, more appropriately.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

A usable recording medium may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### Supplementary Notes

The example embodiments described above may be further described as, but not limited to, the following Supplementary Notes below.

### (Supplementary Note 1)

An information processing system according to Supplementary Note 1 is an information processing system including: an image capture unit that captures a target image including an iris of a target; an image capture time acquisition unit that acquires an image capture time related to image capture by the image capture unit; and an adjustment unit that adjusts a setting value related to the image capture by the image capture unit, based on a change in a light environment corresponding to the image capture time.

### (Supplementary Note 2)

An information processing system according to Supplementary Note 2 is the information processing system according to Supplementary Note 1, further including: an image capture timing acquisition unit that acquires image capture timing of the target image, wherein the adjustment unit adjusts the setting value related to the image capture by the image capture unit, based on a change in a light environment corresponding to both the image capture time and the image capture timing.

### (Supplementary Note 3)

An information processing system according to Supplementary Note 3 is the information processing system according to Supplementary Note 1 or 2, further including: a weather acquisition unit that acquires weather upon capture of the target image, wherein the adjustment unit adjusts the setting value related to the image capture by the image capture unit, based on a change in a light environment corresponding to the image capture time and the weather.

### (Supplementary Note 4)

An information processing system according to Supplementary Note 4 is the information processing system according to any one of Supplementary Notes 1 to 3, further including: a first light environment storage unit that generates and stores first light environment information indicating a relation between the image capture time and a change in a light environment at a location where the target image is captured, by performing preliminary image capture using an object with reflectance similar to that of the iris to near-infrared light, wherein the adjustment unit adjusts the setting value related to the image capture by the image capture unit, based on the first light environment information.

### (Supplementary Note 5)

An information processing system according to Supplementary Note 5 is the information processing system according to any one of Supplementary Notes 1 to 4, further including: a second light environment storage unit that generates and stores second light environment information indicating a relation between the image capture time and a change in a visible light environment and a near-infrared light environment at a location where the target image is captured, by performing preliminary image capture using a visible light camera and a near-infrared camera, wherein the adjustment unit adjusts the setting value related to the image capture by the image capture unit, which is the near-infrared camera, based on the second light environment information and an image captured by the visible light camera upon capture of the target image.

### (Supplementary Note 6)

An information processing system according to Supplementary Note 6 is the information processing system according to any one of Supplementary Notes 1 to 5, further including: a third light environment storage unit that generates and stores third light environment information indicating a relation between the image capture time and a change in a light environment at a location where the image capture unit is installed, based on video data captured at the location where the image capture unit is installed, wherein the adjustment unit adjusts the setting value related to the image capture by the image capture unit, based on the third light environment information.

### (Supplementary Note 7)

An information processing system according to Supplementary Note 7 is the information processing system according to Supplementary Note 6, further including: a transmission unit that transmits the video data captured at the location where the image capture unit is installed, to a second location that is different from the location where the image capture unit is installed; and a generation unit that analyzes the video data at the second location and generates the third light environment information.

### (Supplementary Note 8)

An information processing system according to Supplementary Note 8 is the information processing system according to any one of Supplementary Notes 1 to 7, further including: an identification unit that identifies a similar target with a height close to that of a current target, from among targets previously captured by the image capture unit, wherein the adjustment unit adjusts the setting value related to the image capture by the image capture unit, based on a change in a light environment corresponding to the image capture time upon image capture of the similar target.

### (Supplementary Note 9)

An information processing method according to Supplementary Note 9 is an information processing method in an information processing system including an image capture unit that captures a target image including an iris of a target, the information processing method including: acquiring an image capture time related to image capture by the image capture unit; and adjusting a setting value related to the image capture by the image capture unit, based on a change in a light environment corresponding to the image capture time.

### (Supplementary Note 10)

A recording medium according to Supplementary Note 10 is a recording medium on which a computer program is recorded, the computer program allowing an information processing method to be executed in an information processing system including an image capture unit that captures a target image including an iris of a target, the information processing method including: acquiring an image capture time related to image capture by the image capture unit; and adjusting a setting value related to the image capture by the image capture unit, based on a change in a light environment corresponding to the image capture time.

### (Supplementary Note 11)

A computer program according to Supplementary Note 11 is a computer program allowing an information processing method to be executed in an information processing system including an image capture unit that captures a target image including an iris of a target, the information processing method including: acquiring an image capture time related to image capture by the image capture unit; and adjusting a setting value related to the image capture by the image capture unit, based on a change in a light environment corresponding to the image capture time.

The present disclosure is allowed to be changed, if desired, without departing from the essence or spirit of this disclosure which can be read from the claims and the entire specification. An information processing system, an information processing method, and a recording medium with such changes are also intended to be within the technical scope of the present disclosure.

### DESCRIPTION OF REFERENCE CODES

10 Information processing system
11 Processor
18 Camera
18a Near-infrared camera
18b Visible light camera
110 Image capture time acquisition unit
120 Adjustment unit
130 Image capture timing acquisition unit
140 Weather acquisition unit
210 First light environment storage unit
220 Second light environment storage unit
230 Third light environment storage unit
310 Video data transmission unit
320 Similar target identification unit

What is claimed is:

1. An information processing system comprising:
an image capture unit that captures a target image including an iris of a target;
at least one memory that is configured to store instructions; and
at least one processor that is configured to execute the instructions to:
acquire an image capture time related to image capture by the image capture unit; and
adjust a setting value related to the image capture by the image capture unit, based on a change in a light environment corresponding to the image capture time.

2. The information processing system according to claim 1, wherein the at least one processor is configured to execute the instructions to:
acquire image capture timing of the target image, wherein; and
adjust the setting value related to the image capture by the image capture unit, based on a change in a light environment corresponding to both the image capture time and the image capture timing.

3. The information processing system according to claim 1, wherein the at least one processor is configured to execute the instructions to:
acquire weather upon capture of the target image; and
adjust the setting value related to the image capture by the image capture unit, based on a change in a light environment corresponding to the image capture time and the weather.

4. The information processing system according to claim 1, wherein the at least one processor is configured to execute the instructions to:
generate and store first light environment information indicating a relation between the image capture time and a change in a light environment at a location where the target image is captured, by performing preliminary image capture using an object with reflectance similar to that of the iris to near-infrared light; and
adjust the setting value related to the image capture by the image capture unit, based on the first light environment information.

5. The information processing system according to claim 1, wherein the at least one processor is configured to execute the instructions to comprising:
generate and store second light environment information indicating a relation between the image capture time and a change in a visible light environment and a near-infrared light environment at a location where the target image is captured, by performing preliminary image capture using a visible light camera and a near-infrared camera; and
adjust the setting value related to the image capture by the image capture unit, which is the near-infrared camera, based on the second light environment information and an image captured by the visible light camera upon capture of the target image.

6. The information processing system according to claim 1, wherein the at least one processor is configured to execute the instructions to comprising:
generate and store third light environment information indicating a relation between the image capture time and a change in a light environment at a location where the image capture unit is installed, based on video data captured at the location where the image capture unit is installed; and
adjust the setting value related to the image capture by the image capture unit, based on the third light environment information.

7. The information processing system according to claim 6, wherein the at least one processor is configured to execute the instructions to:
transmit the video data captured at the location where the image capture unit is installed, to a second location that is different from the location where the image capture unit is installed; and
analyze the video data at the second location and generate the third light environment information.

8. The information processing system according to claim 1, wherein the at least one processor is configured to execute the instructions to:
identify a similar target with a height close to that of a current target, from among targets previously captured by the image capture unit; and
adjust the setting value related to the image capture by the image capture unit, based on a change in a light environment corresponding to the image capture time upon image capture of the similar target.

9. An information processing method in an information processing system including an image capture unit that captures a target image including an iris of a target, the information processing method comprising:
acquiring an image capture time related to image capture by the image capture unit; and
adjusting a setting value related to the image capture by the image capture unit, based on a change in a light environment corresponding to the image capture time.

10. A non-transitory recording medium on which a computer program is recorded, the computer program allowing an information processing method to be executed in an information processing system including an image capture unit that captures a target image including an iris of a target, the information processing method including:
acquiring an image capture time related to image capture by the image capture unit; and
adjusting a setting value related to the image capture by the image capture unit, based on a change in a light environment corresponding to the image capture time.
